(19) United States
(12) Patent Application Publication
(10) Pub. No.: US 2017/0259472 A1
(43) Pub. Date: Sep. 14, 2017

(54) CLOSED-CELL POLYURETHANE STRUCTURE METHOD AND SYSTEM

(71) Applicant: Douglas E. Reeves, Edmond, OK (US)

(72) Inventor: Douglas E. Reeves, Edmond, OK (US)

(21) Appl. No.: 15/470,456

(22) Filed: Mar. 27, 2017

Related U.S. Application Data
(63) Continuation-in-part of application No. 13/649,861, filed on Oct. 11, 2012, now abandoned.

(51) Int. Cl. B29C 44/12; B01F 11/00; C04B 38/00; B01F 13/00; B29B 7/00; B29C 44/34; B01F 3/08; B01F 15/00

(52) U.S. Cl. CPC B29C 44/1242; B01F 3/0853; B01F 11/0005; B01F 15/00857; B01F 3/0803; B01F 13/0022; B29B 7/005; B29C 44/3442; C04B 38/0093; B01F 2215/0047; B29K 2075/00

(57) ABSTRACT

A container, that includes a transparent portion, which reveals an interior portion of the container, an access aperture communicating with the interior portion of the container, and a lid adjacent the access aperture. A first liquid component is placed into the interior portion. A second liquid component is poured into the interior portion. The lid of the container is closed to fully enclose the first and second liquid components. The components are agitated until the first and second liquid components are a mixture of uniform color, without an appearance of marbling and swirling, when viewed through the transparent portion of the container. The lid is opened to expose the mixture of uniform color. The mixture of uniform color is poured from the container into a receiving structure. The mixture of uniform color is transformed into a closed-cell polyurethane structure within the receiving structure.

### CROSS REFERENCE TO RELATED APPLICATION

This application is a continuation-in-part of copending U.S. patent application Ser. No. 13/649,861 filed Oct. 11, 2012, entitled “Closed-Cell Polyurethane Structure Method and System.”

### BACKGROUND

The ability to effectively fill pits or rock fissures, or secure poles or soil, etc. can be important for building a variety of structures. Historically, concrete has been used to fill pits or rock fissures, or secure poles or soil. Concrete is heavy and cumbersome to use, especially for smaller projects.

Accordingly, there is a continuing need for methods and systems that can fill and secure structures in a safe and efficient manner

### SUMMARY

In accordance with various embodiments, a method generally features agitating a first liquid component and a second liquid component in a container until the first liquid component and the second liquid component are a mixture of uniform color, without an appearance of marbling and swirling, when viewed through a transparent portion of the container. The mixture of uniform color may be poured from the container into a receiving structure. The mixture of uniform color may be transformed into a closed-cell polyurethane structure within the receiving structure.

In accordance with various embodiments, a method generally features a container that may include a transparent portion that reveals an interior portion of the container, an access aperture communicating with the interior portion of the container, and a lid adjacent the access aperture. A first liquid component may be placed through the access aperture into the interior portion of the container. A second liquid component may be poured through the access aperture into the interior portion of the container. The lid of the container may be closed to fully enclose the first and second liquid components. The first and second liquid components in the container may be agitated until the first and second liquid components are a mixture of uniform color, without an appearance of marbling and swirling, when viewed through the transparent portion of the container. The lid of the container may be opened to expose the mixture of uniform color. The mixture of uniform color may be poured from the container into a receiving structure. The mixture of uniform color may be transformed into a closed-cell polyurethane structure within the receiving structure.

These and various other features and advantages that characterize the claimed invention will be apparent upon reading the following detailed description and upon review of the associated drawings.

### BRIEF DESCRIPTION OF THE DRAWINGS

FIG. 1 shows a side view of an exemplary first container in accordance with various embodiments of the present disclosure.

FIG. 2 illustrates a side view of an exemplary second container in accordance with various embodiments of the present disclosure.

FIG. 3 provides a side view of the exemplary first container supporting the exemplary second container in accordance with various embodiments of the present disclosure.

FIG. 4 displays a side view of the exemplary first container with the lid closed to enclose the mixture in accordance with various embodiments of the present disclosure.

FIG. 5 shows a perspective view with partial cutaway view below a ground surface of an exemplary receiving structure and an exemplary target structure in accordance with various embodiments of the present disclosure.

FIG. 6 provides a flow chart representation of a polyurethane transformation operation in accordance with various embodiments of the present disclosure.

FIG. 7 shows a cross-section view of the target structure centered within the receiving structure, and the liquid mixture disposed within the receiving structure 160.

FIG. 8 shows a cross-section view of the target structure centered in the receiving structure and the closed-cell polyurethane structure encapsulating the target structure.

### DETAILED DESCRIPTION

Reference will now be made in detail to one or more examples of the disclosure depicted in the figures. Each example is provided by way of explanation of the disclosure, and not meant as a limitation of the present disclosure. For example, features illustrated or described as part of one embodiment may be used with another embodiment to yield still a different embodiment. Other modifications and variations to the described embodiments are also contemplated within the scope and spirit of the present disclosure.

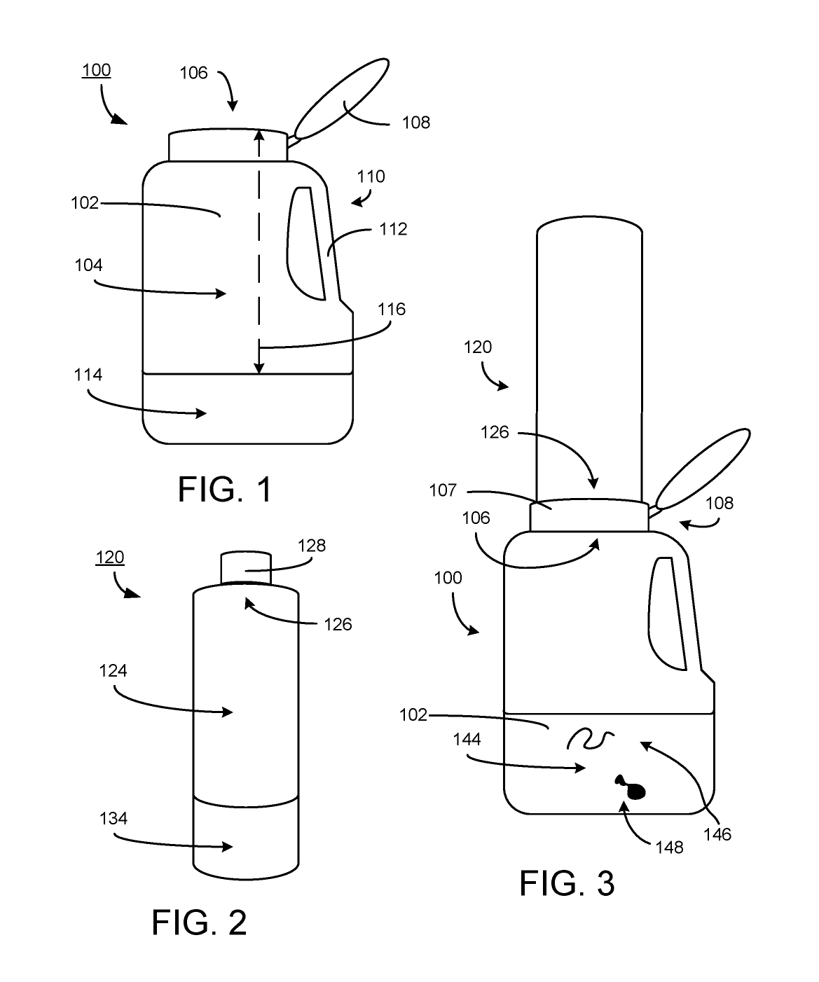

FIG. 1 shows a first container 100. The first container 100 may include: a transparent portion 102; an interior portion 104; an access aperture 106; an attachable cover 107 (the attachable cover 107 provides a permanently attached pressure activated safety lid 108); and a handle 110. In a proffered embodiment, the attachable cover 108, communicates with the access aperture 106 by way of a threaded connection. The transparent portion 102 reveals the interior portion 104 of the container. The access aperture 106 is communicating with the interior portion 104 of the container 100. The lid 108 is adjacent the access aperture 106. The lid 108 may be an integral feature of the first container 100 or may be communicated with the first container 100 via mating threads, snap fastener, or other suitable mechanism. The handle 110 may be sized to permit a finger of a user to wrap substantially all around the handle. An interior portion 112 of the handle 110 may be in fluidic communication with the interior portion 104. The handle 110 may make it easier for the user to move and pour out contents of the first container 100.

The first container 100 may contain a first liquid component 114, and a headspace 116 in the interior portion 104 above the first liquid component 114, wherein the first component is a first liquid component 114. The headspace 116 provides volume in the interior portion 104 of the first container 100 for the first liquid component 114 to be agitated inside the container 100 when the lid 108 is closed.

FIG. 2 illustrates a second container 120. The second container 120 may include an interior portion 124, an aperture 126, and a cap 128. The aperture 126 is communicating with the interior portion 124 of the container 100. The cap 128 is adjacent the aperture 126.

A second liquid component 134 may be placed through the aperture 126 into the interior portion 124 of the second container 120. Wherein the second component 134 is a liquid second liquid component 134.

The first liquid component 114 and the second liquid component 134 may combine to transform the first and second liquid components 114, 134 into a polyurethane, such as a closed-cell polyurethane. Wherein the transformation of the combined, and mixed, first and second liquid components 114 and 134 into the closed-cell polyurethane, results in a volumetric expansion of the mixture, and the transformation of the liquid mixture into a ridged structure.

In an exemplary embodiment of the present disclosure, the first liquid component 114 may belong to the chemical family of polyol system, such as a polyol available from E. I. du Pont de Nemours and Company, commonly referred to as DuPont (Global Headquarters: DuPont Building, 1007 Market Street, Wilmington, Del. 19898).

In an exemplary embodiment of the present disclosure, the second liquid component 134 may belong to the chemical family of the Aromatic Isocyanate with chemical name Diphenylmethane Diisocyanate (MDI). The Aromatic Isocyanate or MDI is available from a variety of sources, such as Dow Chemical Company, commonly referred to as Dow (Corporate Headquarters: The Dow Chemical Company, 2030 Dow Center, Midland, Mich. 48674).

In various embodiments, the first liquid component has a first density and the second liquid component has a second density, and the first density is less than the second density. In addition, the first liquid component has a first viscosity and the second liquid component has a second viscosity, and the first viscosity is greater than the second viscosity.

FIG. 3 illustrates the first container 100 supporting the substantially full weight of the second container 120. The combination of the second container 120 and the first container 100 can be self-supporting such that the second container 120 can be disposed contactingly adjacent the first container 100 without the need for ongoing support from the user or another structure. In this position, substantially all of the second liquid component may pour from the second container 120 into the first container 100 to form a mixture 144. The access aperture 106, the lid 108, and the aperture 126 may be configured and sized so the first container 100 may fully support the second container 120. The first and second liquid components may or may not be hazardous materials, so minimizing the time that the user needs to hold the first and second containers may be beneficial. In addition, the hands of the user may be free to do other things while the second liquid component pours into the first container 100.

As seen in FIG. 3, the mixture 144 may show non-uniform color with an appearance of marbling 146 and swirling 148. The transparent portion 102 has the property of transmitting light without appreciable scattering of the light, such that the mixture 144, the marbling 146, and the swirling 148 are seen clearly. Transparent is different than translucent. Translucent has the property of transmitting and diffusing light so that the mixture 144, the marbling 146, and the swirling 148 beyond could not be seen clearly.

In other words, the first container may support all the weight of the second container, which holds the second liquid component, such that the aperture of the second container and the access aperture of the first container cooperate to form a conduit between the second container and the first container to pour substantially all of the second liquid component into the first container.

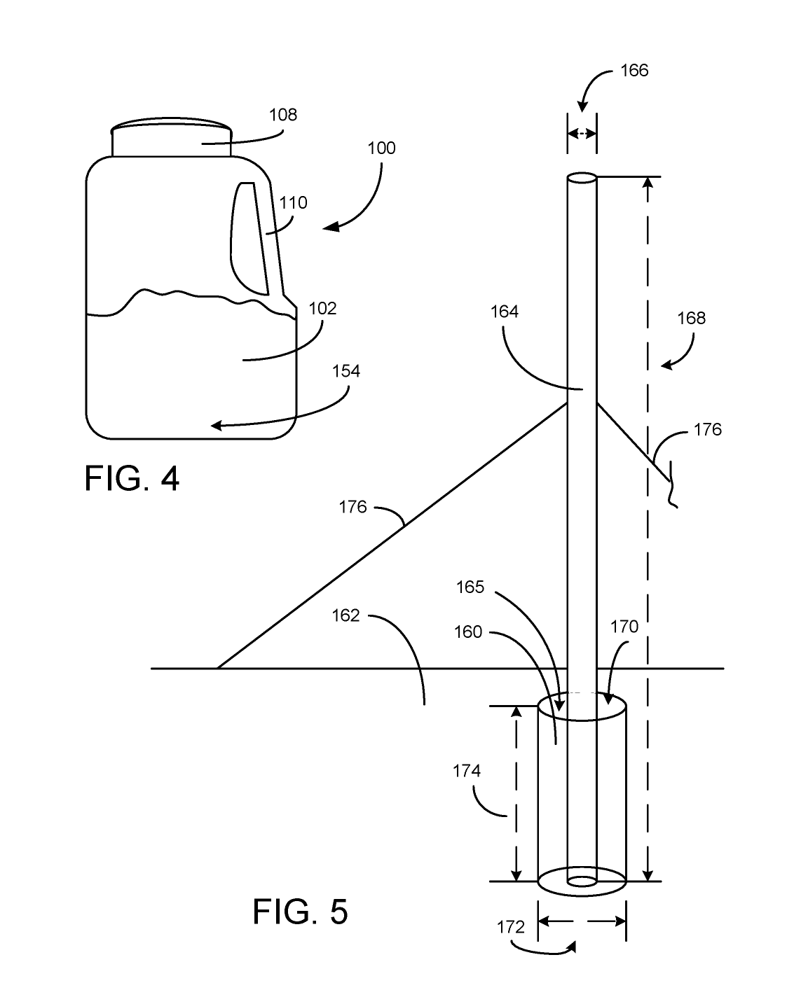

FIG. 4 demonstrates the lid 108 of the first container 100 may be closed with a mixture 154 fully enclosed by the first container 100 in the interior portion 104, and which mixture 154, is a liquid mixture of the first and second liquid components having been fully mix to the point of an absence of swirling and marbling within the liquid mixture 154. The mixture 154 may continue a chemical reaction begun when the first liquid component and the second liquid component came into contact. The chemical reaction is exothermic. The volume occupied by the mixture 154 increases during the chemical reaction; therefore, the pressure increases in the first container 100 when the lid 108 is closed. The lid 108 serves as a pressure relief feature that opens when a pressure in the first container 100 is above a predetermined pressure.

The first and second liquid components may be agitated by manually shaking the container. In other words, the user does not use a machine to agitate the first and second liquid components. For instance, the user could hold the handle 110 of the first container 100 in the hand of the user. In addition, the first and second liquid components may be agitated by mechanically shaking the container via a shaker machine, such as a paint shaker machine. The first and second liquid components could be agitated by mechanically stirring the first and second liquid components via a stirrer, with the lid 108 open or closed.

The first and second liquid components, i.e., the mixture 154, in the first container 100 can be agitated until the first and second liquid components are of uniform color, without the appearance of marbling and swirling, when viewed through the transparent portion 102 of the first container 100. The transparent portion 102 enables the user to clearly see if and when the first and second liquid components are of uniform color, without the appearance of marbling and swirling.

FIG. 5 reveals a receiving structure 160. The mixture of the first and second liquid components can be poured into the receiving structure 160. The receiving structure 160 can be a pit in a ground surface 162, crack in a rock fissure, soil, or other suitable structure that can be secured with the mixture. The receiving structure 160 can encircle a target structure 164 that occupies a predetermined volume of the receiving structure, such that a space 165 between the receiving structure 160 and the target structure 164 remains for receipt of the mixture 154. The target structure 164 could be a standard construction structure, such as a metal pole with an outer diameter 166 of 2 and ⅜ inches and a length 168 of 8 feet. One skilled in the art would understand the term “metal post” to mean a structure of any geometric shape having a length greater than its width and formed from a metallic material such as, but not limited to: iron; steel; stainless steel; aluminum; brass; copper; . . . etc. and may have a hollow core, or solid core. Other suitable target structures may be selected from non-metallic materials, such as: ridged polymers; composites; fiberglass; carbon fiber; wood; . . . etc., including, for example, a 4″ by 4″ wooden post, 1 and ⅝ inch post, such as typically used by DISH Network (Corporate Headquarters: 9601 S. Meridian Blvd., Englewood, Colo. 80112) for mounting a satellite dish, etc.

The mixture of uniform color can transform into a closed-cell polyurethane structure 170 within the receiving structure 160. Upon the completion of the transformation of the mixture 154, into its closed-cell polyurethane structural form, the space 165 between the receiving structure 160, and the target structure 164, is filed, and the closed-cell polyurethane structure 170 is in continuous, pressing contact adjacency with both the interior wall of the receiving structure 160 and the exterior surface of the target structure 164.

The receiving structure 160 can take various forms and sizes. In FIG. 5, the receiving structure 160 has an inner diameter 172 of 6″ and a depth 174 of 24″ when the target structure 164 is the 2 and ⅜ inch metal pole, and the receiving structure 160 has an inner diameter 172 of 8″ and a depth 174 of 24″ when the target structure 164 is 4″ by 4″ wooden post. In either situation, the total volume of the first and second liquid components can be about 28 fluid ounces. When the total volume of the first and second liquid components is about 28 fluid ounces, the volume of the first liquid component can be about 14 fluid ounces and the volume of the second liquid component can be about 14 fluid ounces.

For combinations of the receiving structure 160 and the target structure 164 of these sizes, a range of the total volume of the first and second liquid components can be in a range from about 14 fluid ounces to about 50 fluid ounces. The lower end of the range, e.g., about 14 fluid ounces, may be result in the closed-cell polyurethane structure 170 that is too soft for practical use in supporting the target structure 164 in the receiving structure 160. However, it is contemplated that continued improvements in closed-cell polyurethane structure materials may lead to smaller total fluid volumes yielding the closed-cell polyurethane structure 170 that can support the target structure 164.

The higher end of the end, e.g., about 50 fluid ounces, should result in the closed-cell polyurethane structure 170 that is very strong and effective in supporting the target structure 164, but the high volume of the first and second liquid components may not be viable from an economic standpoint. That is the high end of the total volume of about 50 fluid ounces may cost too much to handle, ship, use, etc. in the marketplace. However, it is contemplated that closed-cell polyurethane structure materials may become cheaper in the future, such that cost is not a limiting factor in choosing the total volume of the first and second liquid components. In addition, about 50 fluid ounces or more may be too heavy for the user to agitate the first and second liquid components.

When the target structure 164 is the 1 and ⅝ inch post, the inner diameter 172 is 6″ and a depth 174 of 18″. In this situation, the total volume of the first and second liquid components may be about 16 fluid ounces. The total volume of the first and second liquid components can be about 16 fluid ounces, with the volume of the first liquid component about 8 fluid ounces and the volume of the second liquid component about 8 fluid ounces. As above, other volumes of the first and second liquid components are possible, and the first and second liquid components may not be of the same volume as each other. For combinations of the receiving structure 160 and the target structure 164 of these sizes, a range of the total volume of the first and second liquid components can be in a range from about 8 fluid ounces to about 28 fluid ounces.

Other volumes of the first and second liquid components are possible. The first and second liquid components may not be of the same volume as each other. In other words, the volume of the first liquid component and the volume of the second liquid component may be volumes other than a one to one (1:1) ratio between the first and second liquid components.

All dimensions provided in the disclosure are approximate, and it is understood that by conventional dimensions may be exemplary, such as the 4″ by 4″ wooden post may actually be 3.5″ by 3.5″.

In a preferred embodiment, the target structure 164, is centered within the receiving structure 160. To sustain this relationship, a stabilization structure 176 may be provided. The target structure 164 may be positioned in the receiving structure 160 in a desired position, i.e. centered. The target structure 164 is stabilized in the receiving structure 160 via cooperation of the stabilization structure 176 with the target structure 164. The stabilization structure 176 engages the target structure 164 and the ground surface 162. There may be a plurality of stabilization structures 176. However, the stabilization structure 176 is optional. For example, the target structure 164 in the receiving structure 160 may be stabilized by the hand of the user in a selected orientation of the target structure 164 in relation to the receiving structure 160.

The target structure 164 may be stabilized in the receiving structure 160 by the user holding the target structure 164 in the desired position.

When the mixture of uniform color has transformed into the closed-cell polyurethane structure 170, the closed-cell polyurethane structure 170 will act to stabilize the target structure 164 in the desired position without ongoing stabilization of the target structure 164 in the receiving structure 160 by the stabilization structure 176, the user, or other suitable manner of stabilization.

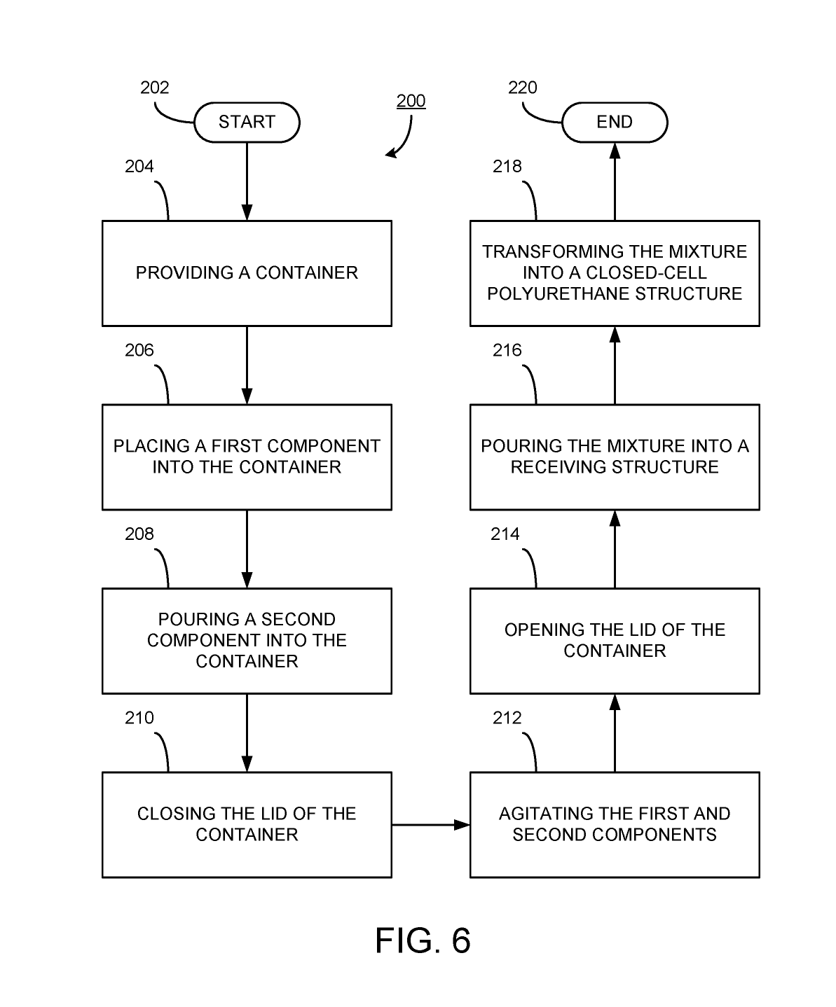

FIG. 6 provides a flow chart for a CLOSED-CELL POLYURETHANE TRANSFORMATION routine 200 illustrative of various steps that may be carried out in accordance with the present disclosure starts at step 202.

At process step 204, a container is provided. The container may include a transparent portion that reveals an interior portion of the container, an access aperture communicating with the interior portion of the container, and a lid adjacent the access aperture.

At process step 206, a first liquid component is placed through the access aperture into the interior portion of the container.

At process step 208, a second liquid component is poured through the access aperture into the interior portion of the container.

At process step 210, the lid of the container is closed to fully enclose the first and second liquid components.

At process step 212, the first and second liquid components in the container are agitated until the first and second liquid components are a mixture of uniform color, without an appearance of marbling and swirling, when viewed through the transparent portion of the container.

At process step 214, the lid of the container is opened to expose the mixture of uniform color.

At process step 216, the mixture of uniform color is poured from the container into a receiving structure.

At process step 218, the mixture of uniform color is transformed into a closed-cell polyurethane structure within the receiving structure.

At process step 220, the routine 200 ends.

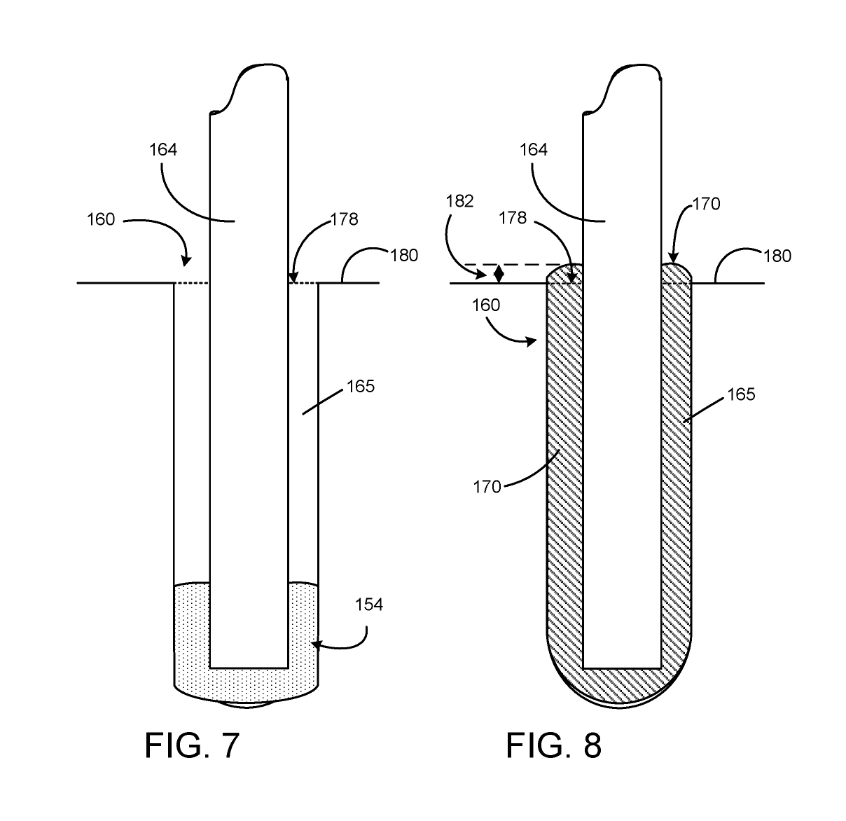

FIG. 7 shows a cross-section view of the target structure 164, centered in the receiving structure 160, and the mixture 154 disposed within the receiving structure 160. The liquid mixture 154, is a combination the first and second liquid components 114 and 134, which has been fully mixed to the point of an absence of swirling and marbling within the liquid mixture 154. Further shown by FIG. 7, is a surface level periphery 178, of the receiving structure 160, and a surface level 180 of a mass within which the receiving structure 160, resides.

FIG. 8 shows a cross-section view of the target structure 164, centered in the receiving structure 160, and the closed-cell polyurethane structure 170, which was transformed from the liquid mixture 154 disposed within the receiving structure 160. Upon the completion of the transformation of the mixture 154, into its closed-cell polyurethane structural form (170), the space 165 between the receiving structure 160, and the target structure 164, is filed, and the closed-cell polyurethane structure 170, is in continuous, pressing contact adjacency with both the interior wall of the receiving structure 160 and the exterior surface of the target structure 164. It is further noted that the closed-cell polyurethane structure 170, when fully expanded, protrudes beyond the surface level periphery 178, of the receiving structure 160, by not less than 25% (182) of the width of the target structure 164, thus encapsulating that portion of the target structure 164, which is positioned within the receiving structure 160. Assuring that the closed-cell polyurethane structure 170, protrudes beyond the surface level periphery 178, of the receiving structure 160, mitigates against a premature degradation of the target structure 164. For example, it is recognized by skilled artisans that a wooden post placed in the ground has a propensity rotten out at about two to five inches below the surface level intersection of the wooden post and the ground. The reason is that moisture build up occurs at that junction, the wood does not have sufficient time to dry out, and wood rot takes hold. The same scenario may occur with steel, and iron posts, i.e., rust through of a steel or iron post first occurs at the post to earth junction.

It should be noted that the various steps are not limited to singular function. That is, several of the steps, such as steps 206 and 208 can be carried out simultaneously. Likewise, the position of the elements of the closed-cell polyurethane transformation can vary without deterring from the spirit of the present disclosure. Regardless, various steps of the operation 200 of FIG. 6 can be omitted, substituted, or repeated as necessary without diverting from the spirit of the present disclosure.

While the present disclosure has been described in connection with an exemplary embodiment, it is not intended to limit the scope of the present disclosure to the particular form set forth, but on the contrary, it is intended to cover such alternatives, modifications, and equivalents as may be included within the spirit and scope of the present disclosure as defined by the appended claims.

It will be clear that the present disclosure is well adapted to attain the ends and advantages mentioned as well as those inherent therein. While exemplary embodiments have been described for purposes of this disclosure, numerous changes may be made which will readily suggest themselves to those skilled in the art and which are encompassed by the appended claims.

What is claimed is:

1. A method comprising the steps of:
providing a receiving structure, the receiving structure providing at least an internal wall, surface level periphery, and a predetermined volume;
placing a portion of a target structure within the predetermined volume of the receiving structure such that a space remains between the periphery of the portion of the target structure placed within the predetermined volume of the receiving structure and the internal wall of the receiving;
providing a container, said container including at least a transparent portion that reveals an interior portion of the container, an access aperture communicating with the interior portion of the container, and an attachable cover that provides a permanently attached pressure activated lid adjacent the access aperture, said pressure activated lid provides pressure relief to the interior portion of the container by automatically opening when a pressure within said interior portion of the container is above a predetermined pressure;
placing a first liquid component through the access aperture into the interior portion of the container;
pouring a second liquid component through the access aperture into the interior portion of the container, the second liquid component poured into the interior of the container directly following the placement of the first liquid component within the interior portion of the container;
closing the lid of the container to fully enclose the first and second liquid components therein;
agitating the first and second liquid components in the container until the first and second liquid components are a liquid mixture of uniform color, without an appearance of marbling and swirling, when viewed through the transparent portion of the container;
opening the lid of the container to expose the liquid mixture of uniform color, without the appearance of marbling and swirling;
pouring the liquid mixture of uniform color, without the appearance of marbling and swirling from the container into the space that remains between the periphery of the target structure and the internal wall of the receiving structure following the placement of the target structure within the predetermined volume of the receiving structure; and
transforming the liquid mixture of uniform color, without the appearance of marbling and swirling into a closed-cell polyurethane structure within the receiving structure, the closed-cell polyurethane structure expands and fills the space in the receiving structure around the target structure, encapsulates that portion of the target structure disposed within the receiving structure, and wherein the target structure has a length greater than its width and formed from a predetermined material, the closed-cell polyurethane structure in pressing contact adjacency with the periphery of the target structure and an inner wall of the receiving structure, the closed-cell polyurethane structure protrudes beyond a surface level of the receiving structure by not less than 25% of the width of the target structure, that portion of the closed-cell polyurethane structure protruding beyond a surface level of the receiving structure mitigates a premature degradation of the target structure.

2. The method of claim 1, in which the receiving structure encircles the portion of the target structure placed within the predetermined volume of the receiving structure, and wherein said single, predetermined material is metallic.

3. The method of claim 1, in which the receiving structure encircles the target structure, and wherein said single, predetermined material is non-metallic.

4. The method of claim 1, in which the first liquid component comprises a polyol.

5. The method of claim 1, in which the second liquid component comprises an aromatic isocyanate.

6. The method of claim 1, in which the second liquid component comprises a diphenylmethane diisocyanate.

7. The method of claim 1, in which the first liquid component has a first density and the second liquid component has a second density, and the first density is less than the second density.

8. The method of claim 1, in which the first liquid component has a first viscosity and the second liquid component has a second viscosity, and the first viscosity is greater than the second viscosity.

9. The method of claim 1, in which the agitating step comprises agitating the first and second liquid components by manually shaking the container.

10. The method of claim 1, in which the agitating step comprises agitating the first and second liquid components by mechanically shaking the container via a shaker machine.

11. The method of claim 1, in which the agitating step comprises agitating the first and second liquid components by mechanically stirring the first and second liquid components via a stirrer.

12. The method of claim 1, in which a mixing ratio of the first liquid component to the second liquid component is substantially equal parts by volume of the first liquid component and the second liquid component.

13. The method of claim 1, in which the total volume of the first liquid component and the second liquid component is about 28 fluid ounces.

14. The method of claim 1, in which the total volume of the first liquid component and the second liquid component is in a range of about 14 fluid ounces to about 50 fluid ounces.

15. The method of claim 1, by steps further comprising:
providing a stabilization structure;
centering said portion of the target structure within the predetermined volume of the receiving structure such that the space that remains between the periphery of the portion of the target structure and the receiving structure is substantially constant around the periphery of the target structure;
stabilizing the target structure in the receiving structure via cooperation of the stabilization structure with the target structure.

16. The method of claim 15, in which the stabilization structure is one of a plurality of stabilization structures that stabilize the target structure in the receiving structure.

17. The method of claim 1, in which the container is characterized as a first container, by steps further comprising:
providing a second container, said second container including at least an interior portion of the second container, and an aperture communicating with the interior portion of the second container;
placing the second liquid component through the aperture into the interior portion of the second container; and
supporting by the first container all the weight of the second container, which holds the second liquid component, such that the aperture of the second container and the access aperture of the first container cooperate to form a conduit between the second container and the first container to pour substantially all of the second liquid component into the first container.

18. The method of claim 17, in which the container has a handle that a hand of a user can wrap substantially all around.

19. An system comprising:
a container including at least a transparent portion that reveals an interior portion of the container, an access aperture communicating with the interior portion of the container, and a lid adjacent the access aperture;
a first liquid component in the interior portion of the container;
a second liquid component in the interior portion of the container, the first and second liquid components in the container form a mixture of uniform color, without an appearance of marbling and swirling, when viewed through the transparent portion of the container; and
a closed-cell polyurethane structure within a receiving structure transformed from the mixture of uniform color.
